(19) United States
(12) Patent Application Publication
(10) Pub. No.: US 2020/0051165 A1
(43) Pub. Date: Feb. 13, 2020

(54) Method and Platform for Community Commercial Transactions

(71) Applicant: Yen-Hung Lai, Changhua County (TW)

(72) Inventor: Yen-Hung Lai, Changhua County (TW)

(21) Appl. No.: 16/101,497

(22) Filed: Aug. 12, 2018

(51) Int. Cl. G06Q 40/04; G06Q 20/36; H04L 9/06

(52) U.S. Cl. CPC G06Q 40/04; H04L 9/0637; G06Q 20/36

(57) ABSTRACT

The present invention provides a method and platform for community commercial transactions, wherein a community trading platform that uses a digital content provider to produce the content, and without having to switch or change interfaces (webpages), the community trading platform enables a single interface (webpage) to complete online platform trading, and by applying smart contracts through blockchain technology a USER can complete online platform trading, and a digital content provider can enable the tracing of sales content.

### BACKGROUND OF THE INVENTION

### (a) Field of the Invention

The present invention relates to a method and platform for community commercial transactions, and more particularly to a community trading platform that uses a digital content provider to produce the content, and without having to switch or change interfaces (webpages), the community trading platform enables a single interface (webpage) to complete online platform trading. By applying smart contracts through blockchain technology a USER can complete online platform trading, and also calculate the total amount of money to be respectively allocated to a product provider and the community trading platform after completing all trading thereon.

### (b) Description of the Prior Art

Current product suppliers or brands can set up their own website (shopping cart) on a general e-commerce website, enabling products to be uploaded or sold to a USER through a general e-commerce platform, such as Amazon, eBay and the like. But such exposed methods of business transactions created by suppliers are limited to network platforms or general e-commerce.

However, in recent years community websites have become a widely popular type of social activity platform, which are extensively used to establish online communities that connect people who possess the same interests and activities. Based on the Internet, they provide various types of contact methods, intercommunication methods, and a plurality of other methods for users to interact, such as e-mail, instantaneous messaging services, video, file sharing, blogs, forum groups, and so on. Current community websites well-established worldwide include Facebook, Youtube, Instagram, Twitter and Google+. However, in such community websites, the user is only able to purely share or advertise content on the platform and is unable to directly carry out business transactions with a supplier (product provider) on a community network.

Furthermore, community commercial affairs in the present market provided by network transaction platforms include the following types of transaction methods: sponsored endorsements to serve as general cooperation between the supplier (product provider) and the digital content provider to post and endorse products, wherein the suppliers (product providers) exposure method created by such business transactions is limited to network platforms, and such one-time cooperation methods forbid the product supplier or brand from tracing sales results. Another transaction method involves a general supplier providing a code and posting products through digital content providers. Although the product supplier or brand is able to trace sales results through a code and connection set up, however, because of untrustworthy relationships, the digital content providers must possess related IT (information technology) technology.

Hence, the aforementioned community commercial trading methods all have common shortcomings, one of which is the inability to use a single interface (webpage), i.e., not having to switch or change the interface (webpage), to conduct content transactions and directly carry out network platform trading.

A second shortcoming is: KOLs (Key Opinion Leaders) or product suppliers (BRANDs) are unable to trace sales results. Hence, existing applications in the technological fields related to community commercial electronic transactions lack a platform and methods that provide related technology to enable effective tracing of sales for integrated digital content providers and brand suppliers. Accordingly, there is a need for assessment and improvement.

### SUMMARY OF THE INVENTION

The primary objective of the present invention is to provide a method and platform for community commercial transactions, wherein a community trading platform uses a digital content provider to produce the content, and without having to switch or change interfaces (webpages), the community trading platform enables a single interface (webpage) to complete online platform trading, and by applying smart contracts through blockchain technology a USER can complete online platform trading. The present invention is establishing a new type of community trading platform that can be used to change current consumer online shopping habits and change the method of use by digital content providers.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a flow chart of a new type of a community trading platform according to the present invention.

FIG. 2 shows a flow chart of the method and platform for community commercial transactions according to the present invention.

FIG. 3 shows an implementation drawing of a commercial model of direct e-commerce platform module according to the present invention.

FIG. 4 shows an implementation drawing of a commercial model of indirect e-commerce platform module according to the present invention.

FIG. 5 shows an implementation drawing of a commercial model of the content medium platform module according to the present invention.

FIG. 6 shows an implementation drawing of a commercial model of the broker platform module according to the present invention.

FIG. 7 shows a flow chart of a logistics model of method and platform for community commercial transactions according to the present invention.

### DETAILED DESCRIPTION OF THE PREFERRED EMBODIMENTS

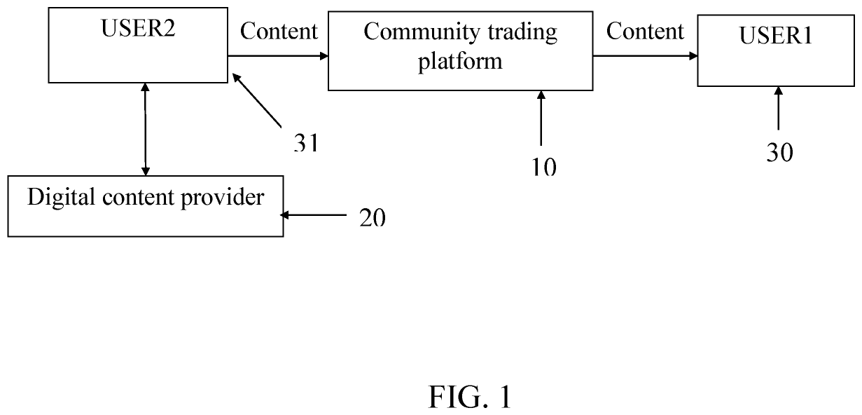

Referring to FIG. 1, which shows a new type of a community trading platform 10 that uses a digital content provider 20 to produce the content and a USER1 30 can complete online platform trading, wherein the digital content provider 20 can be a BRANDs or KOLs (Key Opinion Leaders) or another USER2 31. The USER1 is provided with a personal webpage but is not given an uploading function, they are provided with a re-post and contents collecting function. The USER2 31 in this diagram is a digital content provider 20.

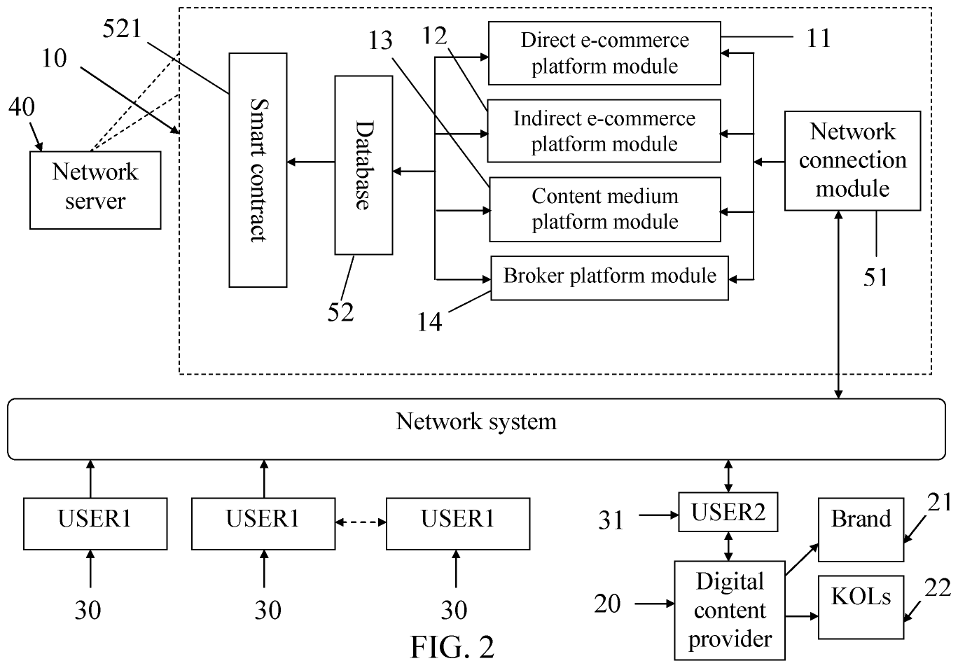

Referring to FIG. 2, which shows a flow chart of method and platform for community commercial transactions according to the present invention, wherein a network system (such as: the Internet) is connected to the database 52 that is established in the community trading platform 10 which also includes transaction modules (not shown in the drawing) that are prestored in the database 52 are all connected to a direct e-commerce platform module 11, an indirect e-commerce platform module 12, a content medium platform module 13, and a broker platform module 14. The USER1 can use a single interface (webpage), i.e., does not need to switch or change the interface (webpage), to carry out online platform trading on the community trading platform 10 and complete their business transactions. The community trading platform 10 of the present invention can also incorporate blockchain transactions through blockchain technological smart contracts 521 to achieve more immediate and more convenient profit sharing. The smart contract 521 is connected to a network server 40 through a network system 50 and enables USER2 31 to trace sales. The aforementioned smart contract 521 uses the network server 40 to activate the Ethereum instructions according to established conditions and transmits information. In an actual embodiment, the aforementioned smart contract 521 can be written in a program language such as: Solidity, Serpent, LLL, EtherScript, Sidechain, and the like, and comprise various different functions, events, parameter states, etc. Using Ethereum as an example, after compilation of conditions, the smart contract 521 obtains a binary code, and uses an Application Binary Interface, abbreviated to ABI, to broadcast the smart contract 521 to a blockchain network, whereby the smart contract 521 is placed on a blockchain and a corresponding address is obtained. Thus, releasing of the smart contract 521 is completed through blockchain transactions.

In actual use, the community trading platform 10 is associated with at least one network server 40 and connected to the network system (such as: Internet) 50, which is used to provide a network trading platform between the digital content provider 20 and the USER1 30, this also enables USER2 31 to be a digital content provider 20. The digital content provider 20 is a Social Media Influencer, abbreviated to SMI, which can also be a brand (i.e., product provider) 21 or KOLs 22. Content is mutually shared between the USER1 30 and another USER1 30, thereby enabling all the USER1 30 to establish an online connection with the direct e-commerce platform module 11, the indirect e-commerce platform module 12, the content medium platform module 13, and the broker platform module 14 through the network system 50. The community trading platform 10 uses blockchain technological smart contracts 521, wherein the system comprises:

The direct e-commerce platform module 11, whereby the USER1 30 is linked via the network server 40 which calculates the total amount of money to be distributed to the brand (i.e., product provider) 21 and associated number of people sharing the profit after completing all transactions on the community trading platform 10.

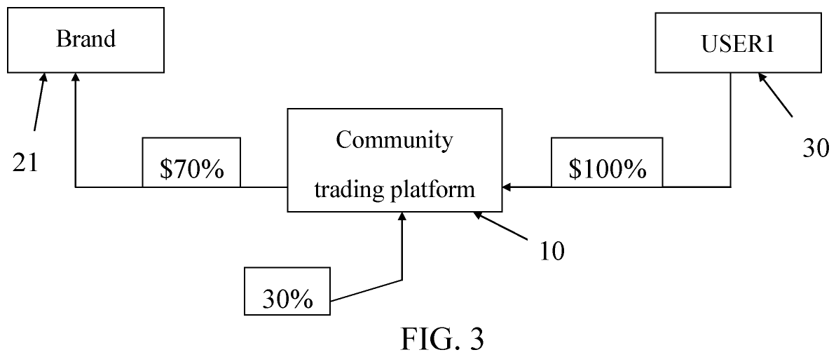

Referring to FIG. 3, which shows an implementation drawing of a commercial model of direct e-commerce platform module according to the present invention, as described below, the percentage of profit sharing after completing transactions is only one embodiment, and the present invention is not limited by such. The USER1 30 completes the online platform transactions with the brand (i.e., product provider) 21 through the community trading platform 10, after which, 100% amount of money is to be shared after the transactions, with 30% being paid to the community trading platform 10 and 70% paid to the brand 21 (i.e., product provider). The indirect e-commerce platform module 12, whereby the USER1 30 uses the network server 40 to connect to the brand (i.e., product provider) 21 to enable mutual transmission of information between the KOLs 22 and the USER1 30, and calculates the amount of money to be respectively appointed to the brands (i.e., product providers) 21 and the KOLs 22 after the completion of trading on the community trading platform 10.

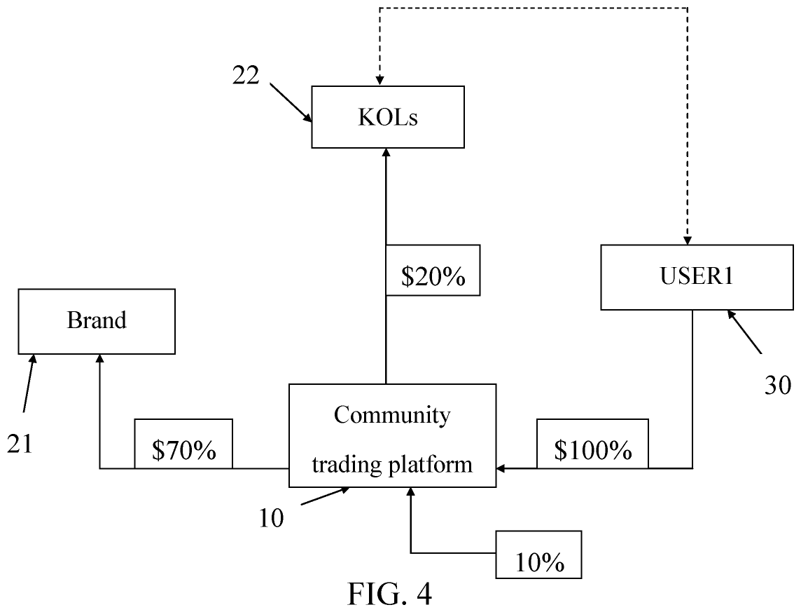

Referring to FIG. 4, which shows an implementation drawing of a commercial model of indirect e-commerce platform module according to the present invention, as described below, the percentage of profit sharing after completing transactions is only one embodiment, the USER1 30 completes online platform transactions with the brand (i.e., product provider) 21 through the community trading platform 10, after which, 100% amount of money is be shared among all parties after the transactions, with 30% being paid to the community trading platform 10, which then pays 20% to the KOLs 22, thus leaving a 10% to the community trading platform 10, and the remaining 70% being paid to the brand 21.

The content medium platform module 13, whereby USER1 30 is linked via the network server 40 which compiles the records of all business transactions completed by the KOLs 22 on the community trading platform 10, it then calculates the amount of money to be divided between the number of people sharing the profit from the business transactions.

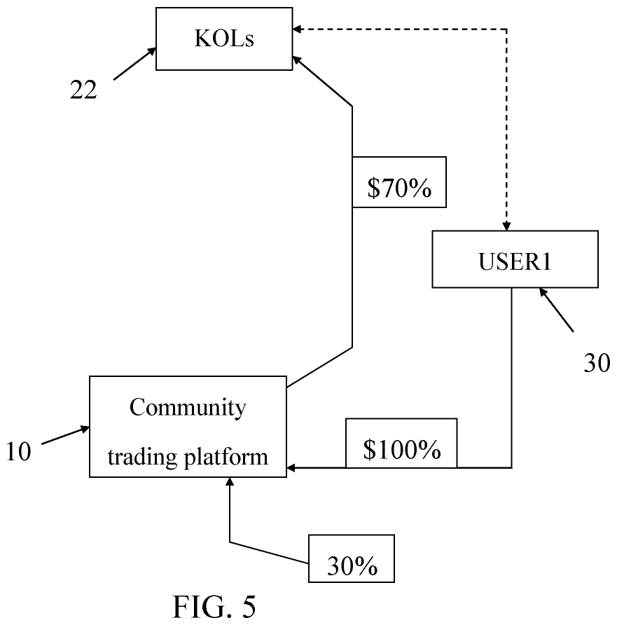

Referring to FIG. 5, which shows an implementation drawing of a commercial model of the content medium platform module according to the present invention, as described below, the percentage of profit sharing after completing transactions is only one embodiment, the USER1 30 uses the community trading platform 10 to complete online platform transactions with the brand (i.e., product provider) 21, after which, 100% amount of money is to be shared between the respected parties after the transaction is completed. The community trading platform 10 allots 30% of the amount to itself, with the other 70% paid to the KOLs 22.

The broker platform module 14, whereby the brand (i.e., product provider) 21 connects and enables mutual transmission of information, product posting, and endorsement content between the KOLs 22 and the community trading platform 10, and furthermore calculates the amount of money to be shared between the KOLs 22 and the community trading platform 10.

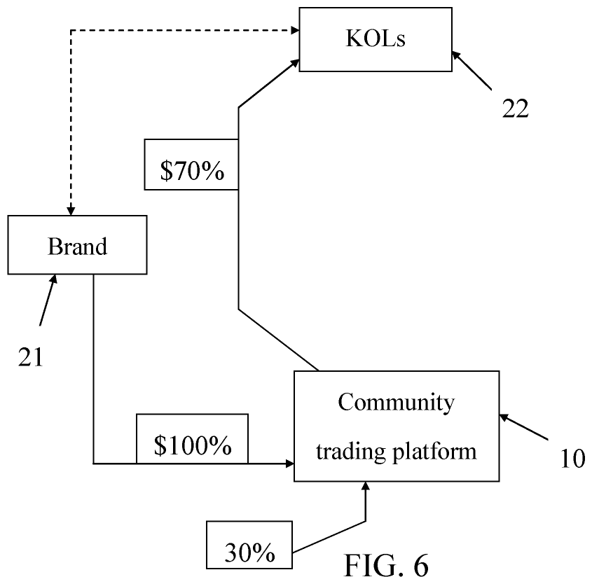

Referring to FIG. 6, which shows an implementation drawing of a commercial model of the broker platform module according to the present invention, as described below, the percentage of profit sharing after completing transactions is only one embodiment, the brand (i.e., product provider) 21 uses the community trading platform 10 to complete online platform transactions with the KOLs 22, after which, 100% amount of money provided by the brand (i.e., product provider) 21 is shared, with 30% being appointed to the community trading platform 10, and the remaining 70% allotted to the KOLs 22.

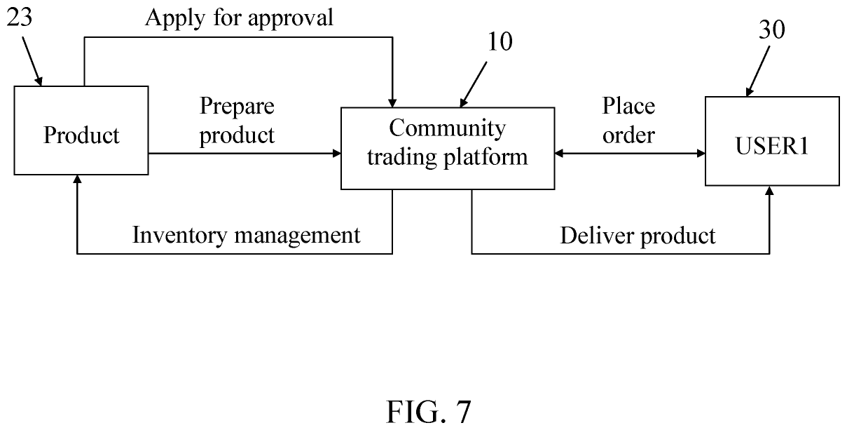

Referring to FIG. 7, which shows a flow chart of a logistics model of method and platform for community commercial transactions according to the present invention, wherein a product 23 applies for approval to be sold which then allows USER1 30 to place an order on the community trading platform 10, and without having to switch or change interfaces (webpages), the community trading platform 10 enables the USER1 30 to use a single interface (webpage) to access the product 23 content and complete their business transaction. The supplier of the product 23 prepares the product for the community trading platform 10, which then carries out inventory management of the product 23, after which the community trading platform 10 delivers the product 23 to the USER1 30 placing the order, thereby completing a logistics model of a community commercial transaction according to the present invention.

In conclusion, according to the above description of the embodiment of the present invention, the community trading platform uses a digital content provider to produce the content, and without having to switch or change interfaces (webpages), the community trading platform enables a single interface (webpage) to complete online platform trading, and by applying smart contracts through blockchain technology a USER can complete online platform trading. The new type of community trading platform of the present invention is capable of accomplishing community commercial electronic transactions efficiently and effectively.

It is of course to be understood that the embodiments described herein are merely illustrative of the principles of the invention and that a wide variety of modifications thereto may be affected.

What is claimed is:

1. A method for community commercial transactions, having application in a network system, which enables a community trading platform to provide a network trading platform for digital content providers and users;
transaction methods on a community commercial trading platform comprise:
establishing a community trading platform, which enables the digital content providers and at least one user to respectively connect to the community commercial trading platform through a network system;
establishing a network system database on the community commercial trading platform, and pre-storing transaction modules in the database;
establishing a direct e-commerce platform module on the community commercial trading platform, wherein the direct e-commerce platform module is used to calculate the total amount of money to be respectively allocated to a product provider and the community trading platform after completing all trading transactions, and calculates the amount of money to be divided between the associated number of people sharing the profit;
establishing an indirect e-commerce platform module on the community commercial trading platform, wherein the indirect e-commerce platform module is used to connect mutual transmission of information between the digital content providers and the users, and calculates the amount of money to be appointed to the product provider, the digital content provider, and the community trading platform after all transactions have been completed;
establishing a content medium platform module on the community commercial trading platform, wherein the content medium platform module is used to calculate the amount of money to be shared between the digital content provider and the community trading platform after all transactions have been completed, and then calculates the amount of money to be given to the digital content provider from the transactions; and
establishing a broker platform module on the community commercial trading platform, wherein the broker platform module is used to connect mutual transmission of information between the database and the digital content providers, and calculates the amount of money the product and the digital content providers respectively share with community trading platform.

2. The method for community commercial transactions according to claim 1, wherein the digital content provider is a Social Media Influencer, abbreviated to SMI, and can also be BRANDs (i.e., product providers) or KOLs.

3. The method for community commercial transactions according to claim 1, wherein the direct e-commerce platform module, indirect e-commerce platform module, content medium platform module, and broker platform module are all connected to transaction modules, and a USER can connect to a network server through a network system, and without having to switch or change interfaces (webpages), the community trading platform enables a single interface (webpage) to complete online platform trading.

4. The method for community commercial transactions according to claim 1, wherein the USER via the network server through network system is connected to the community trading platform, which the USER can go through the direct e-commerce platform module or indirect e-commerce platform module to enable tracing of sales content.

5. The method for community commercial transactions according to claim 1, wherein the direct e-commerce platform module, indirect e-commerce platform module, content medium platform module, and broker platform module connect through a network server, and with application of smart contracts through blockchain technology a USER can complete online platform trading.

6. A platform for community commercial transactions, having application in a network trading platform for digital content providers and users;
transaction platforms on a community commercial trading platform comprise:
a direct e-commerce platform module, wherein is used to calculate the total amount of money to be respectively allotted to a product provider and the community trading platform after completing all trading transactions, and calculates the amount of money to be divided between the associated number of people sharing the profit;
an indirect e-commerce platform module, wherein is used to connect mutual transmission of information between the digital content providers and the users, and also calculates the amount of money to be assigned to the product provider, the digital content provider, and the community trading platform after all transactions have been completed;
a content medium platform module, wherein is used to calculate the amount of money to be shared between the digital content provider and the community trading platform after all transactions have been completed, and calculates the amount of money to be allocated to the digital content provider from the transactions; and
a broker platform module, wherein is used to connect mutual transmission of information between the database and the digital content providers, which then calculates the amount of money the product and the digital content providers respectively share with the community trading platform.

7. The platform for community commercial transactions according to claim 6, wherein the direct e-commerce platform module, indirect e-commerce platform module, content medium platform module, and broker platform module are all connected to transaction modules, a USER can connect to a network server through a network system, and without having to switch or change interfaces (webpages), the community trading platform enables a single interface (webpage) to complete online platform trading.

8. The platform for community commercial transactions according to claim 6, wherein the USER connects to a network server through a network system, and via the community trading platform the USER can go through the direct e-commerce platform module or indirect e-commerce platform module and enable the tracing of sales content.

9. The platform for community commercial transactions according to claim 6, wherein the direct e-commerce platform module, indirect e-commerce platform module, content medium platform module, and broker platform module all work through a network server, and with the application of smart contracts through blockchain technology a USER can complete online platform trading.
